(19) United States
(12) Patent Application Publication
(10) Pub. No.: US 2011/0017922 A1
(43) Pub. Date: Jan. 27, 2011

(54) VARIABLE-TILT TEM SPECIMEN HOLDER FOR CHARGED-PARTICLE BEAM INSTRUMENTS

(75) Inventor: Gonzalo Amador, Dallas, TX (US)

Correspondence Address: John A. Thomas, 14801 Quorum Drive, Suite 500, Dallas, TX, 75254, US

(73) Assignee: OMNIPROBE, INC., Dallas, TX (US)

(21) Appl. No.: 12/509,187

(22) Filed: Jul. 24, 2009

(51) Int. Cl. G21K 5/10

(52) U.S. Cl. 250/442.11

(57) ABSTRACT

A variable-tilt specimen holder for a charged particle instrument having a tilt stage, where the tilt stage has a maximum range of tilt, a sample plate affixed to the tilt stage, and an ion-beam column having an ion-beam column axis. The variable-tilt specimen holder has a base for mounting to the sample plate, so that the base is substantially parallel to the tilt stage. Bearing blocks on the base rotatably support a pivot plate that has slots for holding TEM specimens or TEM grids holding specimens. The pivot plate is rotatable so that the TEM specimens held therein can be aligned with the axis of the ion beam column for thinning of the specimen. The pivot plate has a range of relation sufficient to move the preferred axis of thinning of the specimen from a first position where the tilt stage is placed at its maximum range of tilt and the angle between the preferred axis of thinning of the specimen and the axis of the ion beam column is greater than zero to a second position where the preferred axis for thinning of the specimen is substantially parallel to the ion-beam column axis. Clamps are provided to securely hold the TEM specimens or TEM grids.

### BACKGROUND

The use or focused ion-beam (FIB) microscopes has become common for the preparation of specimens for later analysis in a transmission electron microscope (TEM) or scanning transmission electron microscope (STEM). The in-situ lift-out technique has become the method of choice for the preparation of a tiny specimen for TEM inspection. TEM and STEM inspection offer fine image resolution (<0.1 nm), but require election-transparent (<100 nm thick) sections of the bulk sample. TEM and STEM inspection usually takes place in a separate TEM or STEM device, which requires the transfer of the fragile TEM specimen to another location.

Dual-beam (DB-FIB) instruments having both an ion beam and an electron beam are being more widely used for TEM specimen preparation and inspection. The DB-FIB instrument combines the high-resolution imaging of the SEM with precision, site-specific ion milling of the FIB. The combination of SEM and FIB in the same chamber allows for the location, preparation, and inspection of specimens in the same microscope.

After a specimen is excised from a larger sample, it is preferably moved away from the larger sample by a nano-manipulator system and attached to a TEM specimen grid fur further investigation. A suitable nano-manipulator system is the Omniprobe AutoProbe™, manufactured by Omniprobe, Inc. of Dallas, Tex. Such a nano-manipulator system will typically have a probe part mat is inserted into the vacuum chamber of the FIB instrument.

Existing holders for TEM grids either provide only one orientation of the TEM grid relative to the electron and ion beams, or else allow a limited range of orientations with respect thereto. It is desirable to vary the orientation of an excised TEM specimen to allow better thinning or viewing. It may be advantageous, for example, to perform backside milling of the specimen or shape a MEMS structure in the specimen. Also, existing systems typically rely on tilting the stage of the DB-FIB to vary the angle of the TEM grid holder with respect to the charged-particle beams. Such stages have a limited range of tilt, usually no more than the angle between the electron beam and the ion beam in the instrument. Often, a TEM specimen will require adjustment to an angle with respect to the DB-FIB horizontal that is outside the range of movement of the instrument's tilt stage. This situation can occur, for example, when a probe tip bearing a specimen is attached to a TEM grid, and the attachment operation causes an undesirable rotation of one or more axis of the specimen.

There is a need for a reliable and simple means and method for varying the orientation of the TEM specimen with respect to the charged-particle beams inside the DB-FIB beyond the range available by the tilt stage of the instrument itself, while also securely holding the TEM grid in place during all changes in orientation and maintaining the vacuum inside the instrument chamber.

### DRAWINGS

FIG. 1 shows a perspective view of an embodiment of a variable-tilt TEM grid holder in the upright position with TEM grids placed therein.

FIG. 2 shows a perspective view of an embodiment of a variable-tilt TEM grid holder in the load position.

FIG. 3 shows a perspective view of an embodiment of a variable-tilt TEM grid holder in the inclined state with the gripper of a nano-manipulator probe pushing the pivot plate to change its angle.

FIGS. 4A and 4B shows a partial enlarged perspective view of an embodiment of a variable-tilt TEM grid holder showing two different types of TEM grids and a probe-tip gripper pushing the pivot plate, and an enlarged view of a typical TEM sample before thinning.

FIG. 5 shows an enlarged side view of an embodiment of a variable-tilt TEM grid holder with the pivot plate inclined at about three degrees.

FIG. 6 shows a view of an exemplary sample stage with an embodiment of the variable-tilt TEM grid holder attached to it.

FIG. 7 shows a schematic view of an exemplary DB-FIB system showing an embodiment of the variable-tilt TEM grid holder in the upright position.

FIG. 8 shows a schematic view of an exemplary DB-FIB system showing the variable-tilt TEM grid holder in the inclined position at approximately 5 degrees.

FIG. 9 shows a side view of an exemplary DB-FIB system showing the variable-tilt TEM grid holder in the upright position and the stage of the DB-FIB inclined at about 52 degrees to the horizontal.

FIG. 10 shows a side view of an exemplary DB-FIB system where a variable-tilt TEM grid holder is in the inclined position at approximately five degrees to its own vertical, and the DB-FIB stage is inclined at approximately 52 degrees to the horizontal.

The figures are not necessarily to scale.

### DESCRIPTION

The embodiments of the variable-tilt TEM grid holder disclosed and claimed in this application allow variable orientation of TEM specimens inside a DB-FIB. The field of application is not limited to dual-beam FIB systems or to semiconductor samples. Applications could include, for example, nano-mechanical systems or biological samples, or samples examined in other vacuum or charged particle beam instruments.

The apparatus and methods disclosed in this application provide for improved orientation of a TEM specimen relative to both focused ion and electron beams and higher throughput TEM specimen thinning and preparation within the DB-FIB, because the orientation of the specimen can be adjusted beyond the range possible with the typical DB-FIB tilt stage (360), and further because the specimen does not have to be removed from the microscope to adjust the angle of the specimen relative to the energetic beams.

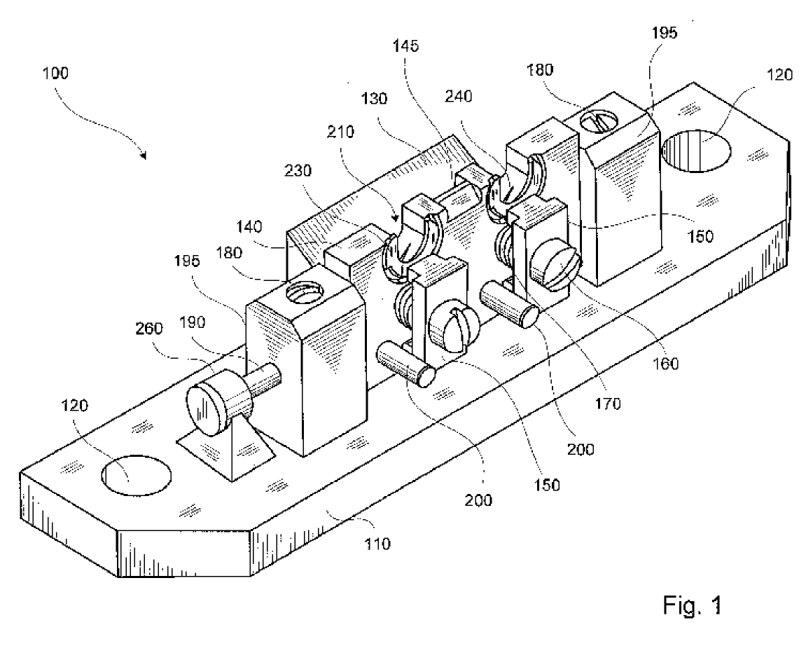

FIG. 1 shows an embodiment of the variable-tilt TEM grid holder (100) that comprises the following basic elements: a base (110), having two mounting holes (120), a pivot plate (140), a hard stop (130) for arresting the rotation of the pivoting plate (140), grid clamps (150), clamp screws (160), compression springs (170), two pivot shafts (190) resting in respective bearing blocks (195), set screws (180) bearing against the pivot shafts (190), and stopper pins (200). The set screws (180) can be tightened against the pivot shafts (190) to create friction, to assist the pivot plate (140) to hold the angle to which it has been rotated. FIG. 1 shows the pivot plate (140) in a vertical orientation. The “vertical orientation” of the pivot plate (140) refers to the configuration where the pivot plate (140) is perpendicular to the base (110).

The pivot plate (140) comprises slots (210) for TEM grids (230). The TEM grids (230) are held against the slots (210) by clamps (150) that are normally biased open by springs (170). The clamps (150) allow easy and secure holding and loading of TEM grids (230). As the damp screw (160) is loosened, the clamp (150) is raised by the compression spring (170) and rotates counterclockwise with the loosening of the right-threaded clamp screw (160) until it rests against the stopper pin (200). This leaves clear access to the TEM grid slot (210) for TEM grid (230) loading or unloading.

The hard stop (130) depicted in the figures is desirable to hold the pivoting plate (140) in a fixed position while the slots (210) are loaded with TEM grids (230) and the clamps (150) are tightened against the TEM grids (230). The height of the hard stop (130) thus determines the maximum angle to which the pivoting plate (140) can be inclined in the direction of the hard stop (130). In other embodiments, the variable-tilt TEM grid holder (100) may be constructed without the hard stop (130), thus allowing a range of movement of the pivoting plate (140) of ±90 degrees or more from its vertical.

FIG. 1 shows the variable-tilt TEM grid holder (100) with two TEM grid slots (210) and with the pivot plate (140) in a vertical orientation with respect to the base (110). There can be more or fewer slots (210) for TEM grids (230) in such a holder (100). FIG. 1 shows both TEM grids (230) secured in place using clamps (150). The approximate dimensions of the embodiment of the variable-tilt TEM grid holder (100) depicted in the drawings are 38 mm×9.7 mm×9.7 mm, which dimensions illustrate the advantageously compact size of the variable TEM grid holder (100). The variable-tilt TEM grid holder (100) material is preferably made of aluminum, but may also be any non-magnetic material.

Although the embodiment of the variable-tilt TEM grid holder (100) just described is shown holding a standard TEM grid (230), it can hold grids or assemblies of other shapes having approximately the same size as the standard TEM grid (230), or the shape of the slots (210) and the clamp (150) could be modified to hold specimens or assemblies of different sizes.

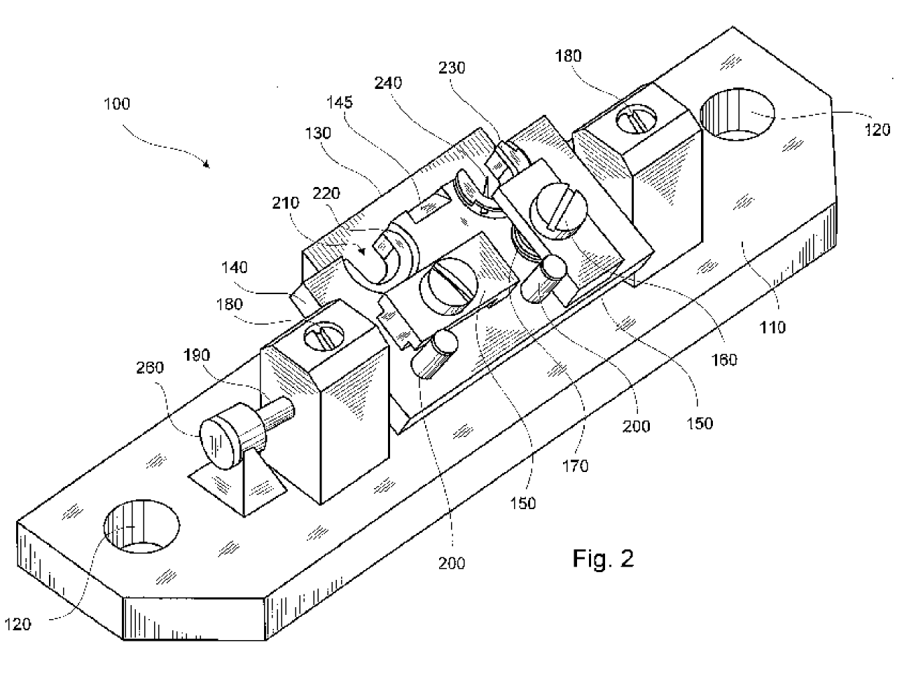

In FIG. 2, the pivoting plate (140) is shown in a loading orientation in an embodiment having a hard stop (130). The clamp (150) on the right in FIG. 2 is in the closed position, and the TEM grid slot (210) there is loaded with a TEM grid (230). The clamp on the left in FIG. 2 is open and the slot (210) there is ready for loading with a TEM grid (230). The slots (210) have a recess (220) in the face of the slot (210) to more securely position the TEM grid (230) inserted therein as it is clamped.

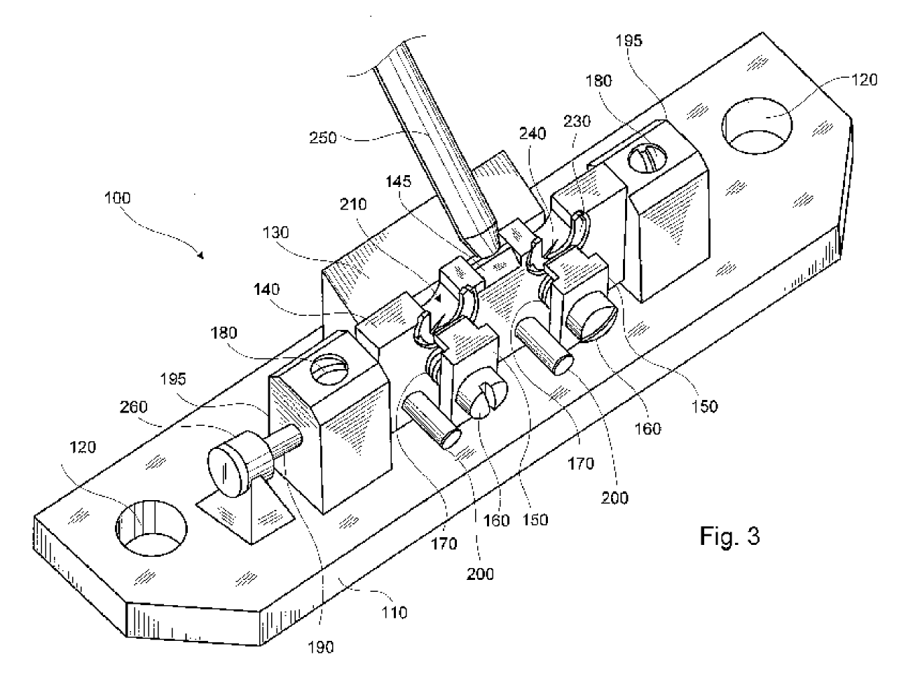

FIG. 3 shows shows a nano-manipulator gripper (250) pushing the pivoting plate (140) to the desired orientation. Both grid clamps (150) are shown in the closed position, holding TEM grids (230). An optional motor (260) can be attached to either one of the shafts (190), to rotate the pivoting plate (140) to the desired angle. The motor is preferably a non-magnetic type, such as a piezo actuator. An example of a suitable motor is one from the MM series motor manufactured by Nanomotion, Ltd. of Ronkonkoma, N.Y. The variable-tilt TEM grid holder (100) disclosed here allows a continuous rotation of a pivoting plate (140) and the TEM specimen (270) attached to it to any desired angle within the range of motion of the pivoting plate (140). When the optional hard stop (130) is present, this range is about ±40 degrees; otherwise it is about ±90 degrees. The TEM grid holder (100) is thus not limited to a pre-determined set of specific rotational angles

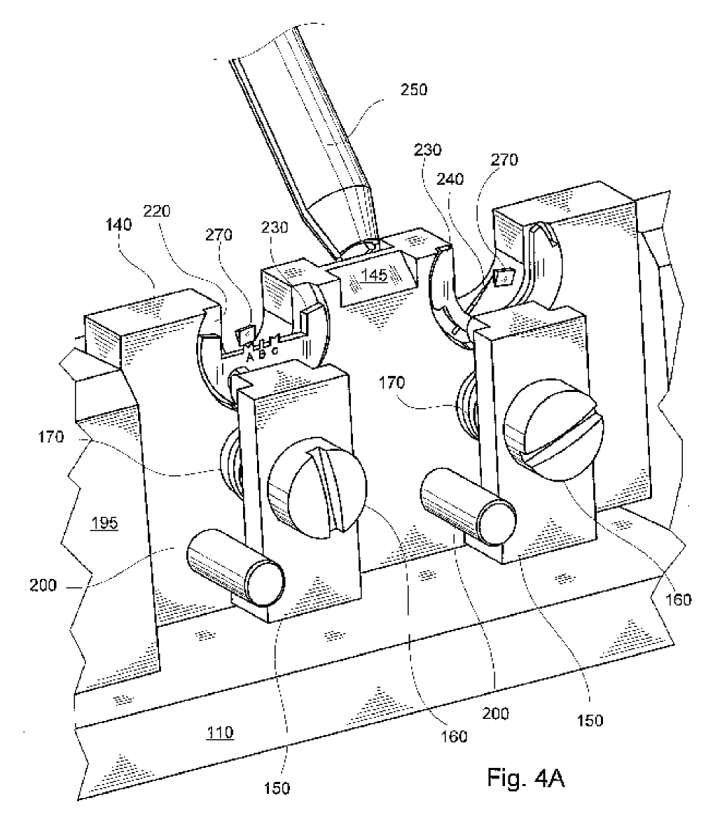

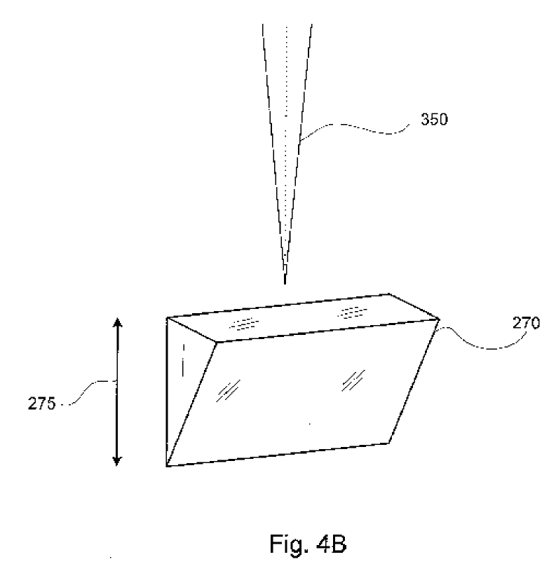

FIG. 4A shows an enlarged view of an embodiment of the variable-tilt TEM grid holder (100). For clarity, the hard stop (130) is not shown in this view. FIG. 4 shows two different types of TEM grids (230) held in the grid holder (100). A standard TEM grid (230) is in the slot (210) on the left of the drawing, and a TEM grid with a probe tip (240) pressed into it by means known in the art is shown in the slot (210) on the right of the drawing.

FIG. 4B shows an enlarged view of a typical TEM specimen (270) after extraction from a larger sample, but before thinning for electron-beam transparency. Such a specimen (270) will have a preferred axis of thinning (275) usually determined by the matter of interest in the specimen (270) and shown in an arbitrary direction in FIG. 4B. Therefore, it is desirable to align the TEM specimen (270) substantially parallel to the ion beam (350) along the preferred axis of thinning (275).

Both TEM grids in FIG. 4A are shown with TEM specimens (270) attached thereto. The TEM grid on the right in the drawing illustrates how a probe tip (240) with a TEM specimen (270) attached to it can be oriented in a way allowing backside milling of the specimen. Alternatively, for example, a MEMS structure or part of it could be directly inserted into the slot (210) and held by the clamp (150) for shaping as desired.

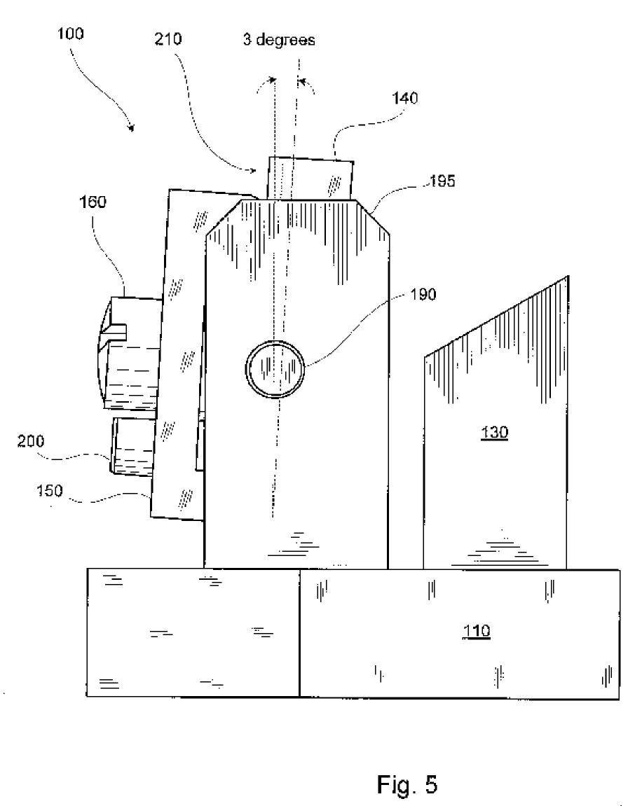

An enlarged side view of an embodiment of the variable-tilt TEM grid holder (100) is shown in FIG. 5. In this example, the pivoting plate (140) is inclined at small angle, here about three degrees, from its vertical orientation.

In the figures, the slots (210) are shown as situated in the plane of the axes of the pivot shafts (190). This embodiment is desirable, since it is then easier to bring the slot (210) and therefore the TEM specimen (270) into parallel with the axis of the ion beam column (320), as later described. If, however, the central axis of the pivoting plate (140) is disposed in the plane of the pivot shafts (190), the same result can be achieved by additionally adjustments the horizontal (X-Y) motion of the DB-FIB stage.

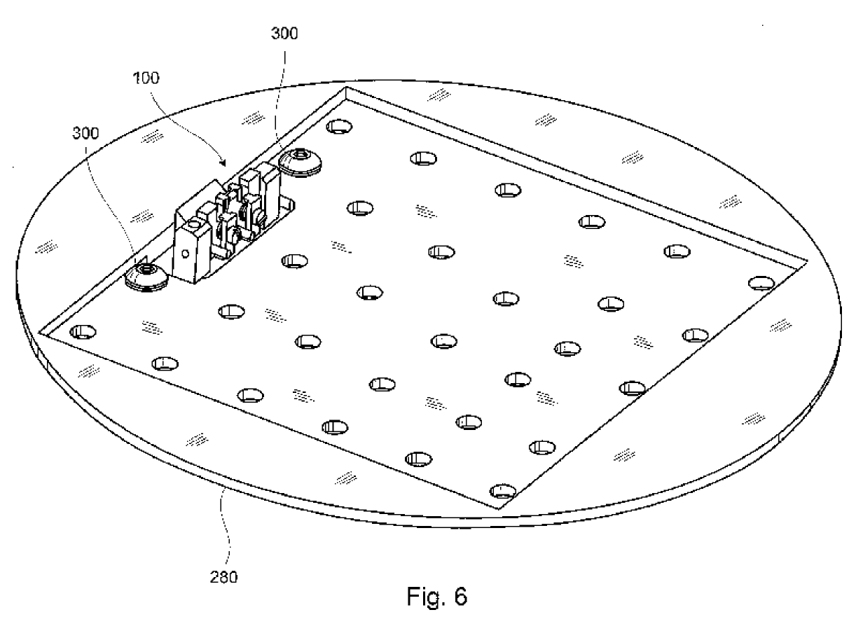

FIG. 6 is a perspective view of a typical sample plate (280) of a DB-FIB instrument, with an embodiment of the variable-tilt TEM grid holder (100) mounted on it. The sample plate (280) shown is typical for the DB-FIB manufactured by FEI Company of Hillsboro, Oreg. However, the variable-tilt TEM grid holder (100) can be adapted to be readily mounted on any other standard sample plate (280), as supplied by FEI Company, JEOL, Zeiss or other DB-FIB manufacturers, preferably by altering the location of mounting holes (120) in the base (110).

The variable-tilt TEM grid holder (100) can be assembled and mounted on the sample plate (280) outside the DB-FIB. It can be placed into the DB-FIB chamber pre-loaded with specimen-laden TEM grids (230), or the TEM grids (230) can be loaded into the TEM grid slots (210) without TEM specimens (270) and the specimens (270) can be attached inside the DB-FIB The variable-tilt TEM grid holder (100) can be mounted on the sample plate (280) using mounting screws (300) through holes (120).

The orientation of the pivoting plate (140) can be changed manually using the gripper (250) shown in FIGS. 3 and 4, or automatically, by using a motor or actuator (260) attached to the pivoting plate shaft (190). The adjustment of the orientation of the TEM specimen (270) can be a part of an automated sample preparation process under control of a programmed computer, as is generally known in the art.

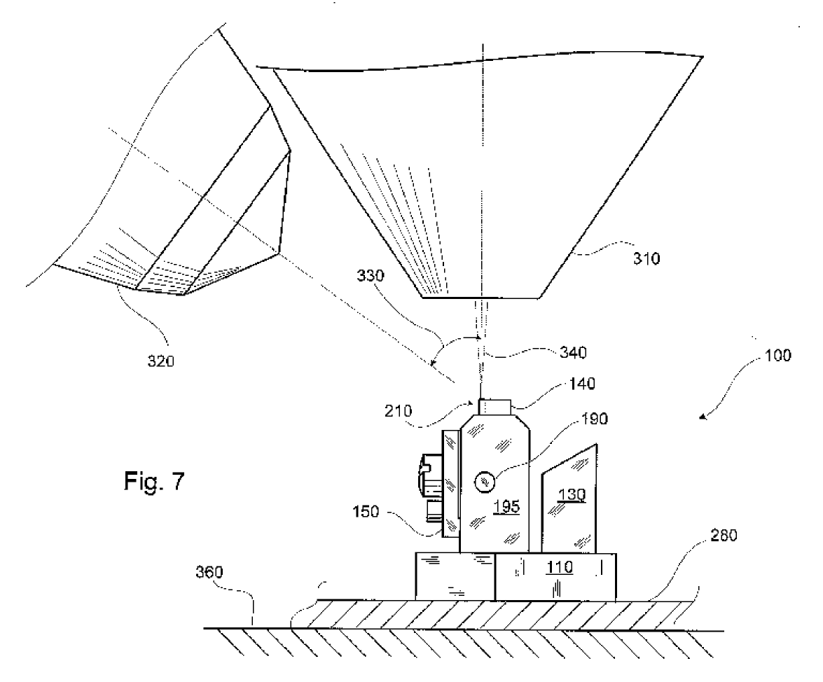

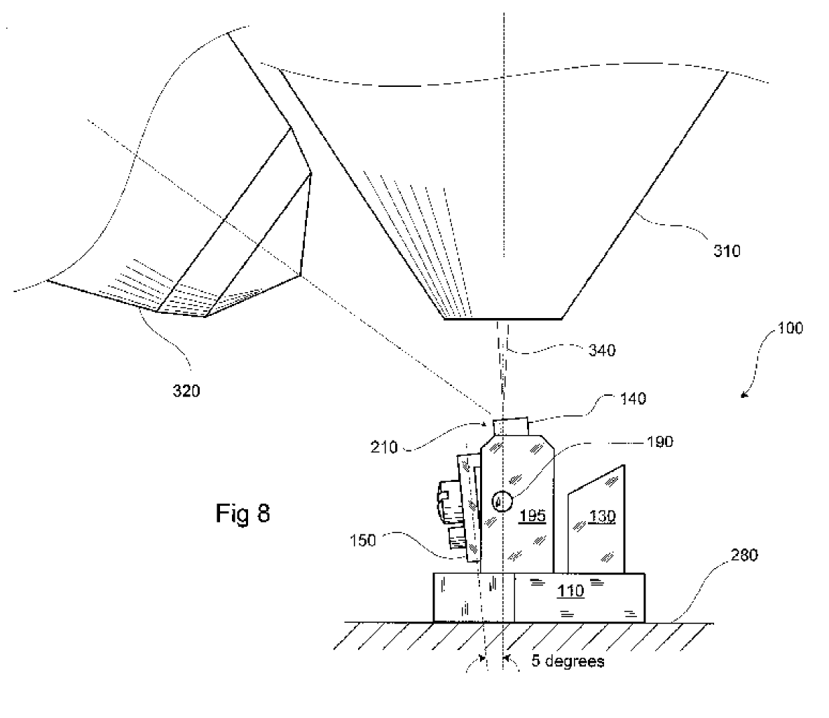

FIGS. 7 through 10 show side view of different orientations or an embodiment of the variable-tilt TEM grid holder (100) inside the DB-FIB microscope. The setup illustrated in these figures includes the electron beam column (310), the ion beam column (320), a sample plate (280) and different orientations of the variable-tilt TEM grid holder (100) attached to the DB-FIB sample plate (280). The angle (330) between the ion-beam and electron-beam columns (330) is approximately 52 degrees for an instrument manufactured by the FEI Company. FIG. 7 shows an embodiment of the variable-tilt TEM grid holder (100) situated on the DB-FIB sample plate (280) with the pivoting plate (140) in a vertical position. The sample plate (280) is of course fixed to the DB-FIB tilt stage (360). In FIG. 1, the tilt stage (360) is not tilted. In FIG. 8, the pivoting plate (140) is inclined at approximately five degrees relative to its vertical. The DB-FIB stage (360) is not tilted in FIG. 8. The case shown in FIG. 8, showing approximately five degrees of rotation of the pivot plate (140) is an example of a case where the specimen (270) is not orientated optimally for milling, and an additional exemplary five-degree rotation of the pivoting plate (140) is required to bring the specimen (270) to a more desirable orientation.

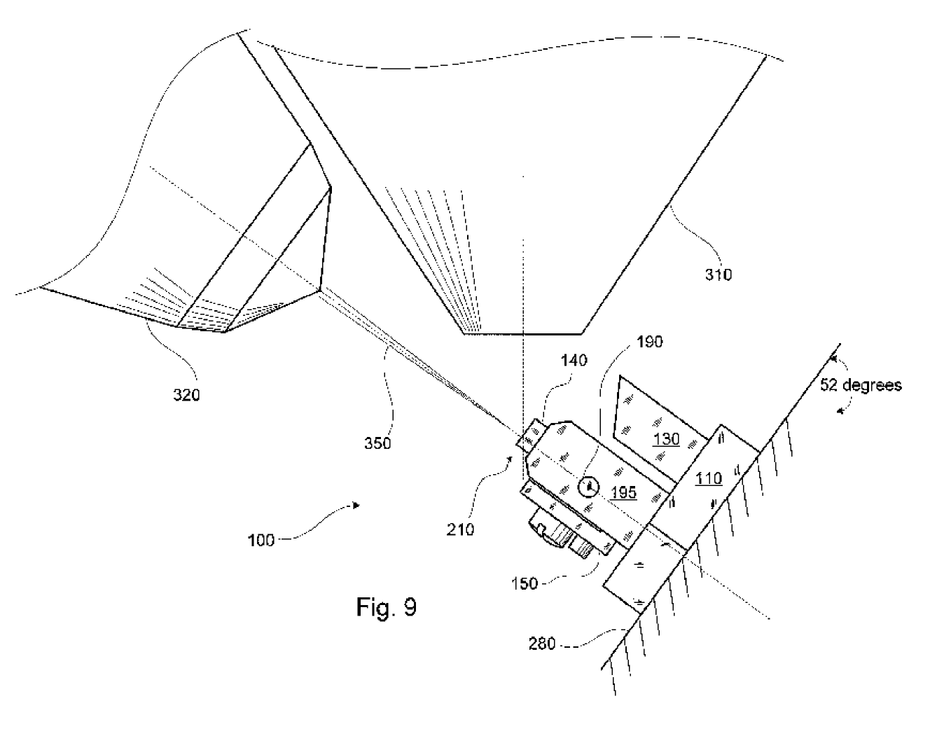

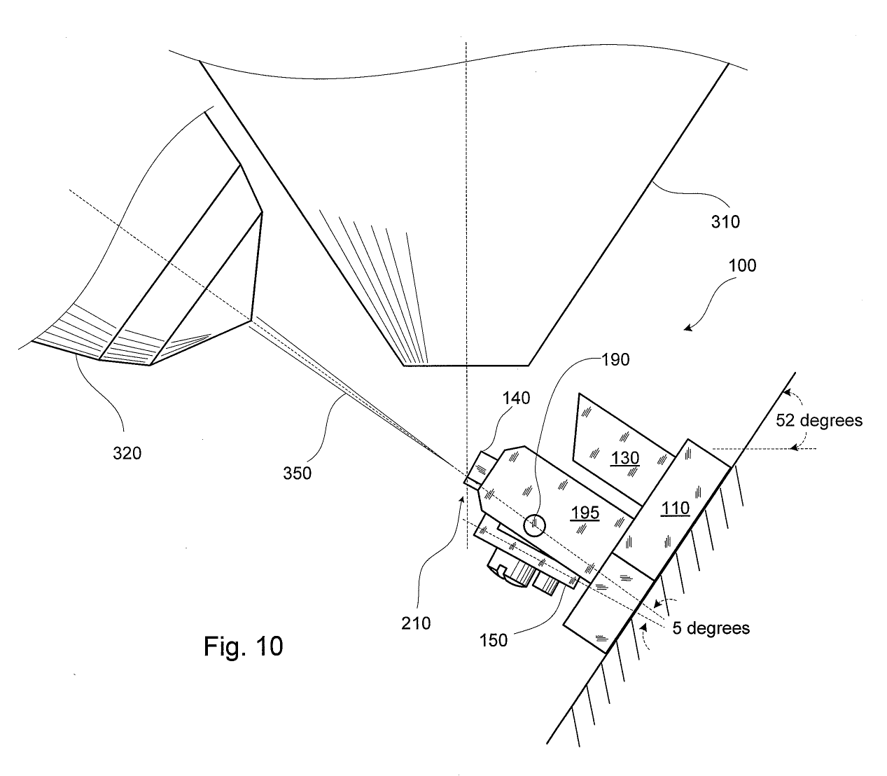

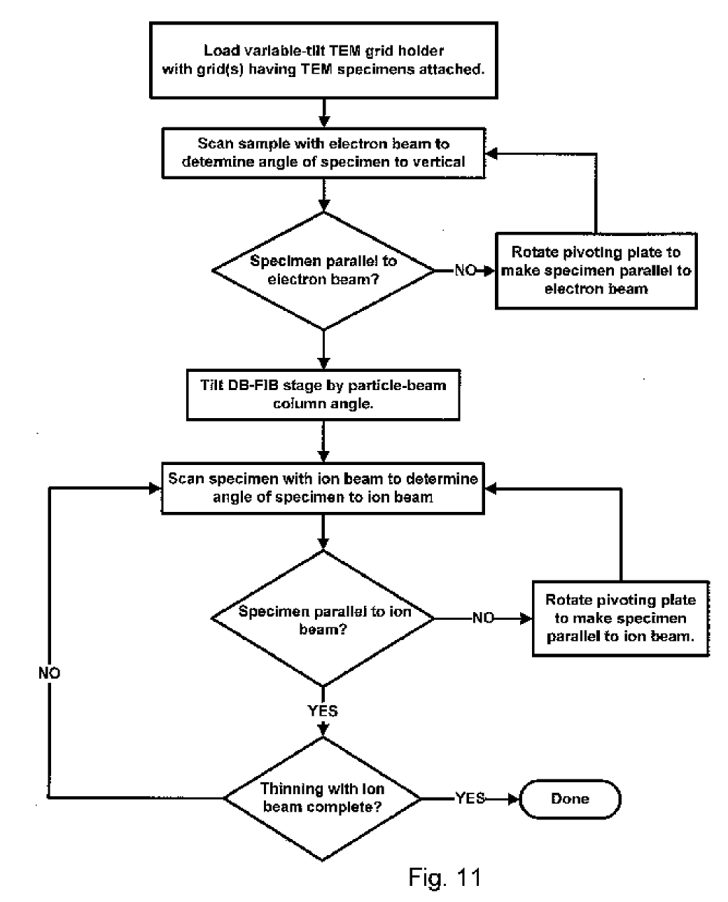

FIG. 9 shows the result of the tilt stage (360) of the DB-FIB inclined at approximately 52 degrees from the horizontal of the DB-FIB, while the pivoting plate (140) is at its own vertical. In FIG. 10, the variable-tilt TEM grid holder (100) is depicted at the same tilt stage (360) orientation as shown in FIG. 9, but with the pivoting plate set at approximately five degrees to its own vertical, thus placing the TEM specimen (270) at an orientation substantially parallel to the ion beam (350). It is assumed that the specimen (270) in FIG. 10 was approximately five degrees offset from its optimal orientation for milling, thus requiring the five-degree correction before the tilting of the tilt stage (360).

The angles shown in FIGS. 7-10 here are exemplary for instruments made by the FEI Company of Hillsboro, Oreg., where the angle between the ion beam column (320) and the electron beam column (310) is 52 degrees. (The electron beam column (310) is assumed vertical with respect to the instrument.) Instruments from other manufacturers may have a different angular relationship between the ion beam column (320) and the electron beam column (340). Therefore, in FIG. 9, for the FEI instrument, the plane of the slots (210) is substantially parallel to the axis of the ion-beam column (320).

To prepare the variable-tilt TEM grid holder (100) for operation, the pivoting plate (140) is brought to the position where it hits the hard stop (130), if present. The clamping screws (160) are loosened and the spring-raised clamp (150) is rotated to expose the TEM grid slot (210). After the TEM grids (230), holding TEM specimens (270), are loaded into their slots (210), they can be secured by clamps (150) turned into the closed position, and the assembly will be ready for operation. Typically, the foregoing operations will be done outside the DB-FIB. The pivoting plate (140) can be rotated to set it at the desired angle using the gripper (250) or a motor (260).

### Method of Operation

The basic steps of the operating process of the variable-tilt TEM grid holder (100) are as follows. First, at least one variable-tilt TEM gild holder (100) is mounted on the sample plate (280) as shown in FIG. 6. Then, at least one TEM grid (230), having a TEM specimen (270) attached to it, is loaded into the slot (210). The first TEM specimen (270) is scanned by the electron beam (340) and its orientation is established. The TEM specimen (270) is preferably made substantially vertical with respect to the DB-FIB and thus parallel to the electron beam (340), so that a first approximation to the desired orientation for thinning is easily made by tilting of the DB-FIB tilt stage (360).

If the TEM specimen (270) is not substantially vertical, the operator chooses an adjustment angle to correct the orientation of the specimen to be parallel to the electron beam, and rotates the pivoting plate (140) through that angle using the gripper (250) or the motor (260).

If the rotation angle is less than desired, an adjustment can be made by any of the means described earlier. If the rotation angle is larger than desired, the tilt stage (360) can be rotated at 180 degrees about the vertical axis of the DB-FIB, and the pivoting plate (140) adjustment can be made from the opposite side of the pivoting plate (140). The relationship between the distance the gripper (250) is moved along the axis of the probe shaft versus total tilt angle achieved can be established experimentally and can be used to determine this distance. The same angle estimation can be used for rotation of the pivoting plate shaft (190), if a motor or other actuator (260) is used. This relationship can be characterized in a lookup table or in an approximate equation with the angular adjustment being the input variable and the displacement of the gripper (250) being the output variable.

After the user finds the TEM specimen (270) to be substantially parallel to the electron beam, the DB-FIB sample stage (330) can be then inclined to the tilt angle estimated to make the preferred axis of thinning (275) of the TEM specimen (270) substantially parallel to the axis of the ion beam column (320). This tilt will generally be the angle between the electron beam column (310) and the ion-beam column (320). This angle is specific to the microscope manufacturer, but in the case of a DB-FIB manufactured by FEI Company, it would be approximately 52 degrees. The TEM specimen (270) can now be thinned by the ion-beam (350) acting substantially parallel to the face of the TEM specimen (270), along its preferred axis of thinning (275). After thinning, the TEM specimen (270) can be examined using the electron beam (340).

It may be the case that the TEM specimen (270) is not substantially parallel to the desired thinning angle, or that the angle of its preferred thinning axis (275) relative to the ion beam (350) is preferably adjusted to accomplish the desired thinning. In this case, the pivoting plate (140) can be rotated as earlier described to bring the preferred thinning axis (275) of the TEM specimen (270) to the desired angle with respect to the ion beam (350). FIGS. 9 and 10 show an example where the stage tilt is 52 degrees and the pivoting plate (140) is rotated by five degrees, thus making the angle between the TEM specimen and the ion beam (350) the desired 52 degrees. In any case, as illustrated, the pivot plate (140) has a range of rotation sufficient to move the preferred axis of thinning (275) of the specimen (270) from a first position where the tilt stage (360) is placed at its maximum range of tilt and the angle between the preferred axis of thinning (275) of the specimen (270) and the axis of the ion beam column (320) is greater than zero to a second position where the preferred axis for thinning of the specimen (275) is substantially parallel to the axis ion-beam column (320) and thus the thinning ion beam (350).

After the thinning process has proceeded for a time, an electron-beam (340) scan can again be made, followed by further pivoting plate (140) adjustment, if needed, and additional thinning. After thinning of all the TEM specimens (270) in a variable-tilt holder (100) is completed, the variable-tilt TEM grid holder (100) holding the TEM specimens can be transferred outside the DB-FIB for further analysis by TEM.

FIG. 11 is an exemplary flow chart illustrating the steps in a process for using the variable-tilt TEM grid holder (100) for thinning a specimen as just described.

None of the description in this application should be read as implying that any particular element step, or function is an essential element, which must be included in the claim scope; the scope of patented subject matter is defined only by the allowed claims. Moreover, none of the claims is intended to invoke paragraph six of 35 USC section 112 unless the exact words “means for” are used, followed by a gerund. The claims as filed are intended to be as comprehensive as possible, and no subject matter is intentionally relinquished, dedicated, or abandoned.

We claim:

1. A variable-tilt specimen holder for a charged particle instrument; the charged-particle instrument having a tilt stage, where the tilt stage has a maximum range of tilt, a sample plate affixed to the tilt stage, an electron-beam column having an electron-beam column axis, and an ion-beam column having an ion-beam column axis; the variable-tilt specimen holder comprising:
a base for mounting the variable-tilt specimen holder to the sample plate of the charged-particle instrument, so that the base is substantially parallel to the tilt stage;
bearing blocks;
the bearing blocks mounted on the base;
a pivot plate;
the pivot plate rotatably supported by the bearing blocks;
the pivot plate having a slot for holding a specimen, where the specimen has a preferred axis for thinning;
the pivot plate having a range of rotation sufficient to move the preferred axis of thinning of the specimen from:
a first position where the tilt stage is placed at its maximum range of tilt and the angle between the preferred axis of thinning of the specimen and the axis of the ion beam column is greater than zero to:
a second position where the preferred axis for thinning of the specimen is substantially parallel to the ion-beam column axis.

2. The variable-tilt specimen holder of claim one, further comprising:
a clamp;
the clamp connected to the pivot plate and adjustable to an open position uncovering the slot and to a closed position preventing the specimen from being removed from the slot.

3. The variable-tilt specimen holder of claim 1, further comprising:
the pivot plate having a vertical position;
the pivot plate being in the vertical position when the pivot plate is substantially perpendicular to the base; and,
the range of motion of the pivot plate being approximately plus or minus 180 degrees from the vertical.

4. The variable-tilt specimen holder of claim 1, further comprising:
the pivot plate having a vertical position;
the pivot plate being in the vertical position when the pivot plate is substantially perpendicular to the base;
a hard stop;
the hard stop situated on the base;
the hard stop having a top surface for stopping the movement of the pivot plate when the pivot plate is rotated by a predetermined angle from the vertical position of the pivot plate.

5. The variable-tilt specimen holder of claim 4 where the range of rotation of the pivot plate is approximately plus or minus 40 degrees from the vertical.

6. The variable-tilt specimen holder of claim 1 where the slot has a recess for receiving a specimen.

7. The variable-tilt specimen holder of claim 1 where the slot is sized to accommodate a specimen grid for a transmission electron microscope.

8. The variable-tilt specimen holder of claim 1 where the pivoting plate has two slots for holding TEM specimens.

9. The variable-tilt specimen holder of claim 1 further comprising a land for engaging the shaft of a nano-manipulator probe to cause rotation of the pivoting plate.

10. The variable-tilt specimen holder of claim 1 further comprising:
a pivot shaft;
the pivot shaft supported by the bearing blocks and rotatable therein;
the pivot shaft connected to the pivot plate and operative to rotate the pivot plate when the pivot shaft is rotated;
an actuator;
the actuator connected to the pivot shaft for selectively rotating the pivot shaft.

11. A method for preparing a specimen inside a charged-particle beam instrument for analysis by electron microscopes, where the charged-particle beam instrument has a tilt stage, an ion-beam column having an ion-beam column axis, an electron beam column having an electron beam column axis, and a variable-tilt specimen holder having a pivot plate capable of variable tilt with respect to the charged-particle beam instrument tilt stage, the method comprising:
placing a sample holder including the specimen for preparation in the pivot plate of the variable-tilt specimen holder;
determining the angle of the sample with respect to the axis of the electron beam column; and,
if the specimen is not substantially parallel to the electron beam column, then rotating the pivot plate to make the specimen substantially parallel to the axis of the electron beam column;
tilting the charged-particle beam instrument tilt stage by the angle of the ion-beam column with respect to the charged-particle beam instrument;
determining the orientation of the specimen with respect to the ion-beam column axis; and,
if the specimen is not substantially parallel to the ion-beam column axis, then rotating the pivot plate to make the specimen substantially parallel to the ion beam before thinning the specimen with the ion beam.
